(19) United States
(12) Patent Application Publication
(10) Pub. No.: US 2025/0354756 A1
(43) Pub. Date: Nov. 20, 2025

(54) ROTARY SINTERING FURNACE

(71) Applicants: TINCI MATERIALS (TAIZHOU) CO., LTD., Taizhou (CN); GUANGZHOU TINCI MATERIALS TECHNOLOGY CO., LTD., Guangzhou (CN)

(72) Inventors: Huiyang XIANG, Taizhou (CN); Haishen SONG, Taizhou (CN); Chao LIU, Taizhou (CN); Litao SHI, Taizhou (CN)

(21) Appl. No.: 19/286,290

(22) Filed: Jul. 31, 2025

Related U.S. Application Data
(63) Continuation of application No. PCT/CN2024/094014, filed on May 17, 2024.

(30) Foreign Application Priority Data
Apr. 9, 2024 (CN) 202410423459.6
Apr. 9, 2024 (CN) 202420728611.7

(51) Int. Cl. F27B 7/38; F27B 7/14; F27B 7/26; F27B 7/34

(52) U.S. Cl. CPC F27B 7/386; F27B 7/14; F27B 7/26; F27B 7/34

(57) ABSTRACT

Provided is a rotary sintering furnace that includes a furnace body assembly and a rapping device. The furnace body assembly includes a heating zone, a heat preservation zone, a cooling zone, a rotary furnace, a first heating device configured to heat the rotary furnace at the heating zone, a second heating device configured to heat the rotary furnace at the heat preservation zone, a cooling device configured to cool the rotary furnace at the cooling zone, and a driving device configured to drive the rotary furnace to rotate. The rapping device is configured to strike the rotary furnace, and includes a first rapping device disposed between the heating zone and the heat preservation zone, and/or a second rapping device disposed between the heat preservation zone and the cooling zone.

### CROSS-REFERENCES TO RELATED APPLICATIONS

This application is a continuation of International Application No. PCT/CN2024/094014, filed on May 17, 2024, which is based on and claims priority to Chinese Patent Application No. 202410423459.6 and Chinese Patent Application No. 202420728611.7, both filed on Apr. 9, 2024, the entire disclosures of which are incorporated herein by reference.

### FIELD

The present disclosure relates to the field of rotary sintering furnaces, and more particularly, to a rotary sintering furnace.

### BACKGROUND

A rotary sintering furnace is a thermal apparatus used for calcining, roasting, or drying granular and powdery materials. The rotary sintering furnace has a combustion system which has advantages of strong technical power, accurate gas distribution, and a low burn loss rate. Therefore, the rotary sintering furnace can be used for drying, dehydration, and roasting of materials in a chemical industry, for example, can be used in production and manufacture of lithium iron phosphate in the new energy field. The rotary sintering furnace used for the production and manufacture of lithium iron phosphate can be an electrothermal continuous production apparatus. Before normal operation, the rotary sintering furnace is preheated. When a temperature of the rotary furnace rises to a temperature required by the process, a material to be roasted is fed into a rotary furnace through a material guide pipe of a feed box of a furnace head. The material is indirectly heated through the rotary furnace to achieve a purpose of roasting. The rotary furnace has spiral blades provided therein, which rotate at a slow speed with the rotary furnace synchronously. The material is roasted in the rotary furnace while being transported to a tail of the furnace through the spiral blade. Finally, the material is fed into a next equipment through a discharge box at the tail of the furnace. When the rotary sintering furnace is used for manufacturing the lithium iron phosphate, it is found that adhesive skin materials and contents of impurities in a lithium-iron-phosphate positive electrode material are too high.

### SUMMARY

The present disclosure aims to at least solve one of the technical problems existing in the prior art. To this end, the present disclosure is to provide a rotary sintering furnace. The rotary sintering furnace is beneficial to reduce the adhesive skin materials and the contents of impurities in the discharging materials.

The rotary sintering furnace according to the embodiments of the present disclosure includes: a furnace body assembly and a rapping device. The furnace body assembly includes a heating zone, a heat preservation zone, a cooling zone, a rotary furnace, a first heating device configured to heat the rotary furnace at the heating zone, a second heating device configured to heat the rotary furnace at the heat preservation zone, a cooling device configured to cool the rotary furnace at the cooling zone, and a driving device configured to drive the rotary furnace to rotate. The rapping device is configured to strike the rotary furnace. The rapping device includes a first rapping device disposed between the heating zone and the heat preservation zone, and/or a second rapping device disposed between the heat preservation zone and the cooling zone.

The rotary sintering furnace according to the embodiments of the present disclosure includes the rotary furnace and the rapping device configured to strike the rotary furnace. The rapping device may be utilized to timely strike off a bonded material inside the rotary furnace, thereby alleviating temperature uniformity of an inner wall of the rotary furnace and reducing the possibility of the material reacting with a furnace wall material. Thus, a problem where the product carries impurities or has an over-sintered material is avoided, thereby improving product quality. Moreover, striking may be performed timely during the sintering process as needed. At this time, the bonded material is relatively little and is thus easy to strike off, with a lower cleaning difficulty and an improvement in cleaning effect. Moreover, since the rapping device may timely strike off the material bonded to the wall of the rotary furnace, over-sintered cladding can be reduced. The bonded material may be mixed into the material in the rotary furnace after being struck off, and is sieved synchronously after discharging. Materials that satisfy a particle size requirement are taken as products for normal use, thereby reducing the waste, and lowering production costs. When the rotary sintering furnace according to the embodiments of the present disclosure is used for manufacturing lithium iron phosphate, the adhesive skin materials in the lithium-iron-phosphate positive electrode material can be reduced, thus lowering the contents of impurities and improving the product quality. In addition, by providing the rapping device, no manual cleaning is required during cleaning, and a cost of manual cleaning is lowered. Moreover, the first rapping device and the second rapping device may correspondingly strike near a position where the material is easy to bond and over-sinter in the rotary furnace, achieving a good effect of striking down the material. Moreover, the first rapping device does not influence mounting and operation of the first heating device and the second heating device. An arrangement position of the first rapping device is not easily affected by a high temperature. Moreover, the first rapping device is easy to mount and maintain. The second rapping device does not influence mounting and operation of the second heating device and the cooling device. An arrangement position of the second rapping device is not easily affected by the high temperature. Moreover, the second rapping device is easy to mount and maintain.

In some embodiments, the furnace body assembly is provided with a first heat preservation housing at the heating zone and a second heat preservation housing at the heat preservation zone. The first heat preservation housing and the second heat preservation housing are spaced apart from each other. The first rapping device is disposed at a spacing region between the first heat preservation housing and the second heat preservation housing; and/or the second rapping device is disposed at a side of the second heat preservation housing away from the first heat preservation housing.

In some embodiments, the first heating device is externally disposed at the rotary furnace and fixed in the first heat preservation housing; the second heating device is externally disposed at the rotary furnace and fixed in the second heat preservation housing; and each of the first heating device and the second heating device includes a heating unit. The heating unit includes a plurality of electric heaters arranged side by side in a length direction of the rotary furnace.

In some embodiments, the rotary furnace is provided with the heating unit at each of a top and a bottom of the rotary furnace.

In some embodiments, the cooling device includes a covering housing and a spray device. The spray device is externally disposed at the rotary furnace, and the covering housing covers the spray device.

In some embodiments, the rapping device is externally disposed at the furnace body assembly; and/or the rapping device further includes a third rapping device disposed at a side of the heating zone away from the heat preservation zone; and/or the rapping device further includes several fourth rapping devices that are arranged at the heating zone and/or the heat preservation zone.

In some embodiments, the rotary sintering furnace further includes a support and an air source device. The rapping device includes a striking head that is extendable; the support is disposed outside the rotary furnace, the rotary furnace being rotatable with respect to the support, and the rapping device being disposed at the support; and the air source device is disposed at the support and connected to the rapping device, to drive the striking head to extend or retract to strike the rotary furnace.

In some embodiments, an axis of the rotary furnace is horizontally oriented. The rapping device is disposed above a central horizontal plane of the rotary furnace, and an angle a1 between a reciprocating direction of the striking head and the central horizontal plane of the rotary furnace ranges from 10° to 80°.

In some embodiments, the rotary furnace is provided with one rapping device at each of two sides of a central vertical plane of the rotary furnace, the two rapping devices are symmetrically arranged with respect to the central vertical plane, and an angle a2 between reciprocating directions of the two rapping devices ranges from 30° to 120°.

In some embodiments, the support includes: two vertical frames that are located at two sides of the rotary furnace, respectively; a horizontal frame connected between the two vertical frames; and inclined frames connected between the two vertical frames and the horizontal frame. The two vertical frames are each provided with the air source device, and the two rapping devices are mounted at the inclined frames.

In some embodiments, the rotary furnace is provided with a first cushion member in a circumferential direction of the rotary furnace, and the striking head is configured to act on the first cushion member to strike the rotary furnace; and/or an air source pressure of the air source device ranges from 0.35 MPa to 0.7 MPa, and a striking frequency of the rapping device ranges from once per 5 seconds to once per 5 minutes.

In some embodiments, the rapping device includes a plurality of striking units arranged at intervals in a circumferential direction of the rotary furnace. Each of the plurality of striking units includes a pipe member and a striking member. The pipe member has an end fixed to the rotary furnace and another end extending away from a central axis of the rotary furnace; and the striking member is disposed in the pipe member and slidable with respect to the pipe member. The striking member is configured to strike the rotary furnace.

In some embodiments, a second cushion member is disposed in the pipe member and/or at an outer wall of the rotary furnace, the striking member being configured to act on the second cushion member to strike the rotary furnace; and/or the pipe member is internally provided with an elastic float at an end of the pipe member close to the rotary furnace. The elastic float includes a float and a spring. The spring is configured to push the float to move away from the rotary furnace. An area of the float is greater than an area of the striking member, and the striking member is configured to strike the rotary furnace by the float.

In some embodiments, the driving device is disposed between the heat preservation zone and the cooling zone. The driving device includes a drive motor, a speed reducer, and a transmission gear, and the rotary furnace is provided with a gear ring surrounding the rotary furnace. The transmission gear is engaged with the gear ring, and the drive motor is configured to drive the transmission gear through the speed reducer to rotate; and/or a rotational speed of the rotary furnace ranges from 8 minutes per revolution to 15 minutes per revolution.

In some embodiments, the rotary sintering furnace is a lithium-iron-phosphate rotary sintering furnace, and the rotary furnace includes a furnace body and a spiral blade. The spiral blade is disposed at an inner wall of the furnace body to synchronously rotate with the furnace body, and each of the furnace body and the spiral blade is made of stainless steel or alloy; and/or a polishing degree of each of the inner wall of the furnace body and a surface of the spiral blade is smaller than 3 μm.

Additional aspects and advantages of the present disclosure will be provided in part in the following description, or will become apparent in part from the following description, or can be learned from practicing of the present disclosure.

### BRIEF DESCRIPTION OF THE DRAWINGS

FIG. 1 is a schematic view of a rotary sintering furnace according to an embodiment of the present disclosure.

FIG. 2 is a top view of a rotary sintering furnace according to an embodiment of the present disclosure.

FIG. 3 is a schematic view of a furnace body assembly according to an embodiment of the present disclosure.

FIG. 4 is a main view of the rotary sintering furnace shown in FIG. 2.

FIG. 5 is a schematic view of an air-hammer rapping device according to an embodiment of the present disclosure.

FIG. 6 is a schematic view of a rotary sintering furnace according to an embodiment of the present disclosure.

FIG. 7 is a schematic view of a rotary sintering furnace according to another embodiment of the present disclosure.

FIG. 8 is a schematic view of a rotary sintering furnace according to yet another embodiment of the present disclosure.

FIG. 9 is a schematic view of cooperation between a rotary furnace and a fourth rapping device according to an embodiment of the present disclosure.

### REFERENCE NUMERALS

rotary sintering furnace 1000;
furnace body assembly 100; heating zone 101; heat preservation zone 102; cooling zone 103;
rotary furnace 1; furnace body 1a; spiral blade 1b;
first furnace zone 11; second furnace zone 12; third furnace zone 13; first region 14; second region 15;
central horizontal surface S1; central vertical surface S2; first cushion member 16; second cushion member 17;
heating device 2; first heating device 21; second heating device 22; heating unit 20; electric heater 201;
cooling device 3; covering housing 31; spray device 32;
driving device 4; drive motor 41; speed reducer 42; transmission gear 43; gear ring 44;
heat preservation housing 5; first heat preservation housing 51; second heat preservation housing 52;
rapping device 200;
first rapping device 61; second rapping device 62; third rapping device 63; fourth rapping device 64;
air-hammer rapping device 7; striking head 70;
metal substrate 71; permanent magnet 72; magnetic piston 73; return spring 74;
striking unit 8; pipe member 81; striking member 82; elastic float 83; float 831; spring 832;
support 300;
vertical frame 301; horizontal frame 302; inclined frame 303;
air source device 400;
air source pressure control system 91; solenoid valve 92; air source pipe 93; time relay 94.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

Various embodiments or examples for implementing different structures of the present disclosure are provided below. In order to simplify the description of the present disclosure, components and configurations of specific examples are described below. These specific examples are merely for the purpose of illustration, rather than limiting the present disclosure. Further, the same reference numerals and/or reference letters may appear in different examples of the present disclosure for the purpose of simplicity and clarity, instead of indicating a relationship between the discussed various embodiments and/or configurations. In addition, the present disclosure provides examples of various specific processes and materials. However, applications of other processes and/or the use of other materials are conceivable for those of ordinary skill in the art.

The rotary sintering furnace is a thermal apparatus used for calcining, roasting, or drying granular and powdery materials. The rotary sintering furnace has a combustion system which has advantages of strong technical power, accurate gas distribution, and a low burn loss rate. Therefore, the rotary sintering furnace can be used for drying, dehydration, and roasting of materials in a chemical industry, for example, can be used in production and manufacture of lithium iron phosphate in the new energy field. The rotary sintering furnace used for the production and manufacture of lithium iron phosphate can be an electrothermal continuous production apparatus. Before normal operation, the rotary sintering furnace is preheated. When a temperature of the rotary furnace rises to a temperature required by the process, a material to be roasted is fed into a rotary furnace through a material guide pipe of a feed box of a furnace head. The material is indirectly heated through the rotary furnace to achieve a purpose of roasting. The rotary furnace has spiral blades provided therein, which rotate at a slow speed with the rotary furnace synchronously. The material is roasted in the rotary furnace while being transported to a tail of the furnace through the spiral blade. Finally, the material is fed into a next equipment through a discharge box at the tail of the furnace.

However, when the rotary sintering furnace is used for manufacturing the lithium iron phosphate, it is found that adhesive skin materials and contents of impurities in a lithium-iron-phosphate positive electrode material are too high. Through research, the present disclosure creatively finds the following facts. During sintering of a lithium iron phosphate material in the rotary sintering furnace, due to characteristics of lithium iron phosphate material itself, the material is likely to be bonded at an inner wall of the rotary furnace or on the spiral blade in the rotary furnace, thereby affecting temperature uniformity of the inner wall of the rotary furnace and causing an excessively high local temperature. That is, the rotary furnace has partially an excessively high temperature due to the bonded material. Thus, the material is likely to react with a material of a furnace wall of the rotary furnace, such that the obtained product carries impurities or has an over-sintered material, affecting the product quality. Moreover, when the bonded material is sintered at a high temperature for a long time, the material is likely to form over-sintered cladding. That is, after the material is bonded on the inner wall of the rotary furnace, flake-like solid may be formed by sintering or over-sintered, with a size greater than a required particle size of the material, thereby affecting electric performances of the product, such as charge-discharge cycling performance. The solid cannot be used for normal purposes after recovery, resulting in waste and an increase in production costs. At present, the inner wall of the rotary furnace is usually cleaned manually. However, it is inconvenient for an operator to access the interior of the rotary furnace for cleaning, and the cleaning is such troublesome and dangerous that it has to be performed after the sintering. In this case, the bonded materials are more and thicker, making the cleaning process more difficult and resulting in poor cleaning effectiveness.

To this end, the present disclosure provides a rotary sintering furnace 1000. The rotary sintering furnace 1000 includes a rotary furnace 1 and a rapping device 200 configured to strike the rotary furnace 1. The rapping device 200 may be utilized to timely strike off the bonded material inside the rotary furnace, thereby alleviating the temperature uniformity of the inner wall of the rotary furnace 1 and reducing the possibility of the bonded material reacting with a furnace wall material. Thus, a problem where the product carries impurities or has the over-sintered material is avoided, thereby improving the product quality. Moreover, striking may be performed timely during the sintering process as needed. At this time, the bonded material is relatively little and is thus easy to strike off, with a lower cleaning difficulty and an improvement in cleaning effect. Moreover, since the rapping device 200 may timely strike off the material bonded to the wall of the rotary furnace, the over-sintered cladding can be reduced. The bonded material may be mixed into the material in the rotary furnace 1 after being struck off, and is sieved synchronously after discharging. Materials that satisfy a particle size requirement are taken as products for normal use, thereby reducing the waste, and lowering production costs. In addition, by providing the rapping device 200, no manual cleaning is required during cleaning, and a cost of manual cleaning is lowered. When the rotary sintering furnace 1000 according to the embodiments of the present disclosure is used for manufacturing the lithium iron phosphate, the adhesive skin materials in the lithium-iron-phosphate positive electrode material can be reduced, thus lowering the contents of impurities and improving the product quality.

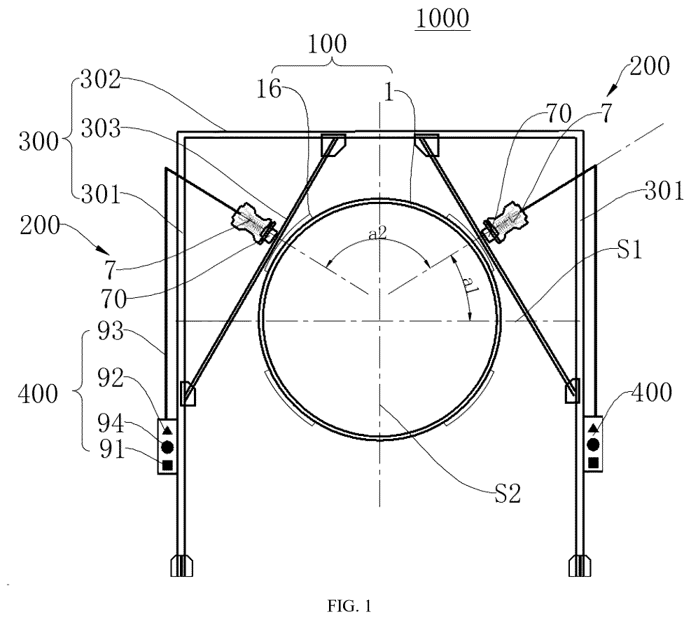

In some embodiments of the present disclosure, as shown in FIG. 1 to FIG. 3, the rotary sintering furnace 1000 includes: a furnace body assembly 100 and a rapping device 200. The furnace body assembly 100 includes a heating zone 101, a heat preservation zone 102, a cooling zone 103, the rotary furnace 1, a first heating device 21 configured to heat the rotary furnace 1 at the heating zone 101, a second heating device 22 configured to heat the rotary furnace 1 at the heat preservation zone 102, a cooling device 3 configured to cool the rotary furnace 1 at the cooling zone 103, and a driving device 4 configured to drive the rotary furnace 1 to rotate. The rapping device 200 is configured to strike the rotary furnace 1, and includes a first rapping device 61 disposed between the heating zone 101 and the heat preservation zone 102, and/or a second rapping device 62 disposed between the heat preservation zone 102 and the cooling zone 103.

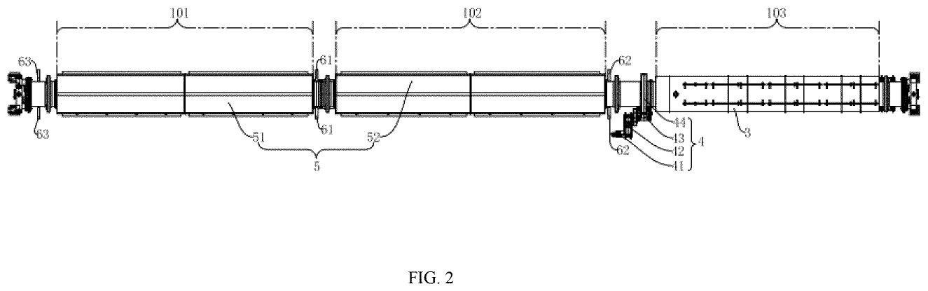

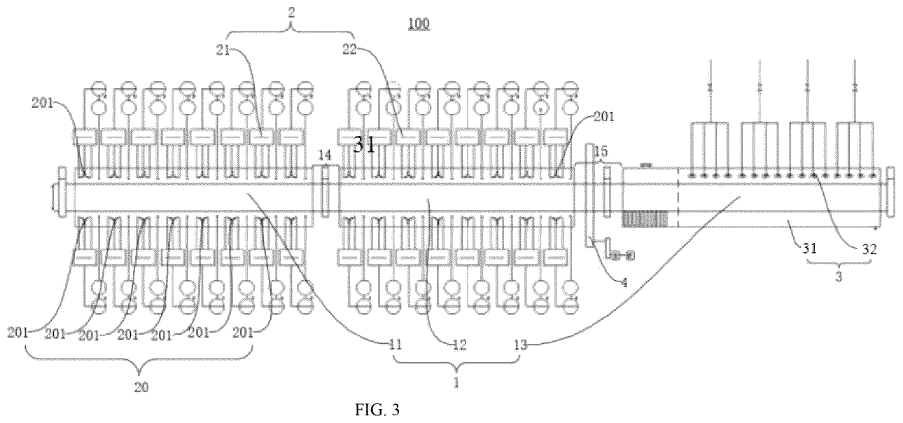

Exemplarily, in combination with FIG. 2 and FIG. 3, the furnace body assembly 100 includes the rotary furnace 1, a heating device 2, a cooling device 3, and a driving device 4. The rotary furnace 1 includes a first furnace zone 11, a second furnace zone 12, and a third furnace zone 13 that are sequentially arranged. The heating device 2 includes the first heating device 21 disposed outside the first furnace zone 11, and the second heating device 22 disposed outside the second furnace zone 12. The cooling device 3 is disposed outside the third furnace zone 13. The driving device 4 is connected to the rotary furnace 1 to be configured to drive the rotary furnace 1 to rotate.

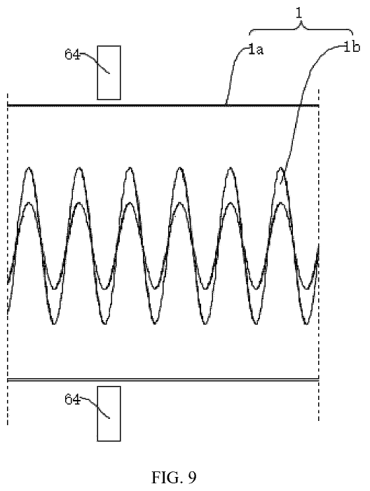

Exemplarily, the rotary furnace 1 is an integrally cylindrical structure. However, the rotary furnace 1 is not required to be an entire cylinder body, for example, it may be composed of a plurality of sections of cylinders rigidly connected to each other. The rotary furnace 1 includes the first furnace zone 11, the second furnace zone 12, and the third furnace zone 13 that are integrally formed, driven by one driving device 4, and rotate synchronously under the driving action of the driving device 4. Exemplarily, in combination with FIG. 9, the rotary furnace 1 has a spiral blade 1b provided therein. The spiral blade 1b rotates synchronously with the rotary furnace 1. In this way, the material in the rotary furnace 1 is pushed to move in a direction from the first furnace zone 11 to the second furnace zone 12, and then moves to the third furnace zone 13 with the rotation of the spiral blade 1b during the rotation of the rotary furnace 1.

Exemplarily, the first furnace zone 11 may be connected to the feed box. The third furnace zone 13 may be connected to the discharge box. The material enters the first furnace zone 11 from the feed box. With the rotation of the rotary furnace 1, the material is driven by the spiral blade 1b in the rotary furnace 1 to enter the second furnace zone 12 from the first furnace zone 11, then enter the third furnace zone 13 from the second furnace zone 12, and is finally discharged into the discharge box. When entering the first furnace zone 11, the material may be heated stepwise, for example, be heated gradually from a room temperature to a temperature ranging from 700° C. to 800° C., then enter the second furnace zone 12 to be heated at a constant temperature, such as at a constant temperature ranging from 700° C. to 800° C., then enter the third furnace zone 13 to be cooled down, and finally be discharged from the discharge box.

Exemplarily, as shown in FIG. 1, the rapping device 200 is externally disposed in the furnace body assembly 100, i.e., any one of the rapping devices 200 (such as any one of the first rapping device 61, the second rapping device 62, and the third rapping device 63) is disposed outside all of the components contained in the furnace body assembly 100, such that the rapping device 200 is disposed outside the rotary furnace 1 to be used for striking on the rotary furnace 1. Therefore, by providing the rapping device 200 outside the rotary furnace 1, the rapping device 200 is not in direct contact with the material in the rotary furnace 1, to avoid interference of the rapping device 200 on material transportation and heating, enabling roasting of the material in the rotary furnace 1 to be performed smoothly. Moreover, a temperature in the rotary furnace 1 does not affect operation of the rapping device 200, and operation stability of the rapping device 200 can be improved.

In embodiments of the present disclosure, the rapping device 200 may include at least one of the first rapping device 61 and the second rapping device 62, i.e., the rapping device 200 may include only the first rapping device 61, or only the second rapping device 62, or both the first rapping device 61 and the second rapping device 62. In combination with FIG. 2 and FIG. 3, the first rapping device 61 is disposed corresponding to a connection (a first region 14) between the first furnace zone 11 and the second furnace zone 12, so that the first rapping device 61 can strike a position of the rotary furnace 1 located between the first furnace zone 11 and the second furnace zone 12. The second rapping device 62 is disposed corresponding to a connection (a second region 15) between the second furnace zone 12 and the third furnace zone 13, so that the second rapping device 62 can strike a position of the rotary furnace 1 located between the second furnace zone 12 and the third furnace zone 13.

As stated above, during the sintering of the lithium iron phosphate material in the rotary sintering furnace 1000, due to the characteristics of the lithium iron phosphate material itself, the material is easy to be bonded at the inner wall of the rotary furnace 1 or at the spiral blade 1b in the rotary furnace 1. A temperature of the first furnace zone 11 gradually increases in a direction from the feed box to the second furnace zone 12, and a temperature of the second furnace zone 12 is thermostatically high. Therefore, at a position of the first furnace zone 11 close to the second furnace zone 12 and in the second furnace zone 12, after the material is bonded to the furnace wall and the spiral blade 1b, it is more likely to cause over-sintered skinning of the material or reaction of the material with the furnace wall material of the rotary furnace due to the excessively high local sintering temperature of the material, which further leads to a problem of material loss or impurities carried in the product.

When the first rapping device 61 is provided to strike the position of the rotary furnace 1 located between the first furnace zone 11 and the second furnace zone 12, it is beneficial to striking-off the bonded materials inside the first furnace zone 11 and the second furnace zone 12. When the second rapping device 62 is provided to strike the position of the rotary furnace 1 located between the second furnace zone 12 and the third furnace zone 13, it is beneficial to the striking-off of the bonded material inside the second furnace zone 12. Therefore, by providing at least one of the first rapping device 61 and the second rapping device 62, it is beneficial to striking at the vicinity of the rotary furnace 1 to which the over-sintered material is easily bonded, which can effectively strike off the bonded material.

Moreover, since the first rapping device 61 is disposed between the heating zone 101 and the heat preservation zone 102, the first rapping device 61 is disposed corresponding to the connection (the first region 14) between the first furnace zone 11 and the second furnace zone 12, so that the first rapping device 61 can be disposed in a position avoiding the first heating device 21 and the second heating device 22, i.e., the first rapping device 61 can be disposed between the first heating device 21 and the second heating device 22, thus facilitating the mounting of the first rapping device 61. Since the second rapping device 62 is disposed between the heat preservation zone 102 and the cooling zone 103, the second rapping device 62 is disposed corresponding to the connection (the second region 15) between the second furnace zone 12 and the third furnace zone 13, so that the second rapping device 62 can be disposed in a position avoiding the second heating device 22 and the cooling device 3, i.e., the second rapping device 62 can be disposed between the second heating device 22 and the cooling device 3, thereby facilitating the mounting of the second rapping device 62.

In short, with the rotary sintering furnace 1000 according to the embodiments of the present disclosure, the first rapping device 61 and the second rapping device 62 may correspondingly strike near a position where the material is easy to bond and over-sinter in the rotary furnace 1, achieving a good effect of striking down the material. Moreover, the first rapping device 61 does not influence mounting and operation of the first heating device 21 and the second heating device 22. An arrangement position of the first rapping device 61 is not easily affected by the high temperature. Moreover, the first rapping device 61 is easy to mount and maintain. The second rapping device 62 does not influence mounting and operation of the second heating device 22 and the cooling device 3. An arrangement position of the second rapping device 62 is not easily affected by the high temperature. Moreover, the second rapping device 62 is easy to mount and maintain.

In some embodiments of the present disclosure, the furnace body assembly 100 is provided with a first heat preservation housing 51 at the heating zone 101 and a second heat preservation housing 52 at the heat preservation zone 102. The first heat preservation housing 51 and the second heat preservation housing 52 are spaced apart from each other.

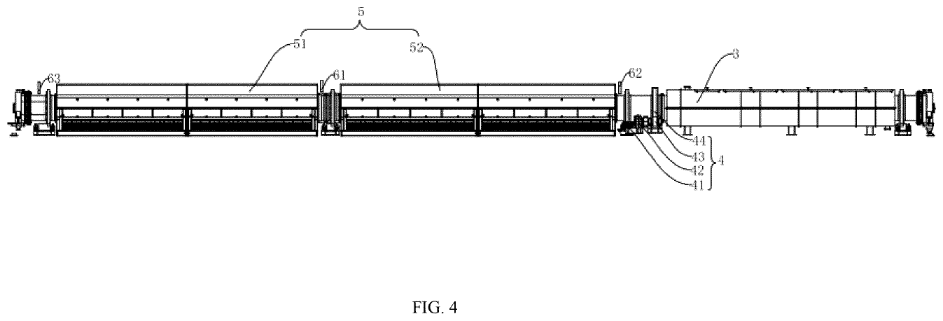

Exemplarily, in combination with FIG. 3 and FIG. 4, the furnace body assembly 100 further includes a heat preservation housing 5. When the rapping device 200 is disposed outside the heat preservation housing 5 when being externally disposed at the furnace body assembly 100. The heat preservation housing 5 includes a first heat preservation housing 51 covering the first heating device 21 and the first furnace zone 11, and a second heat preservation housing 52 covering the second heating device 22 and the second furnace zone 12. Thus, by providing the heat preservation housing 5, heat loss can be reduced, enabling the heat to be sufficiently used for heating the rotary furnace 1, thereby enhancing a heat utilization rate and reducing sintering costs.

In combination with FIG. 3 and FIG. 4, in some embodiments of the present disclosure, when the rapping device 200 includes the first rapping device 61, the first rapping device 61 may be disposed at a spacing region between the first heat preservation housing 51 and the second heat preservation housing 52. Therefore, the arrangement position of the first rapping device 61 is less likely to be affected by high temperatures within the first heat preservation housing 51 and the second heat preservation housing 52. Moreover, because the first rapping device 61 is externally disposed at the heat preservation housing 5, the first rapping device 61 is thus easy to mount and maintain.

In combination with FIG. 3 and FIG. 4, in some embodiments of the present disclosure, when the rapping device 200 includes the second rapping device 62, the second rapping device 62 may be disposed at a side of the second heat preservation housing 52 away from the first heat preservation housing 51. Therefore, the arrangement position of the second rapping device 62 is less likely to be affected by the high temperature within the second heat preservation housing 52. Moreover, because the second rapping device 62 is externally disposed at the heat preservation housing 5, the second rapping device 62 is thus easy to mount and maintain.

It is worth noting that the heat preservation housing 5 is not limited in terms of the composition thereof. For example, the heat preservation housing 5 may include a metal housing and a heat preservation layer formed on an inner wall of the metal housing, such as a heat preservation brick and heat preservation cotton. In this way, heat is effectively locked in the heat preservation housing 5, and a heat waste is lowered.

In some embodiments of the present disclosure, the heating device 2 is fixed in the heat preservation housing 5. The first heating device 21 is externally disposed at the rotary furnace 1 and fixed in the first heat preservation housing 51. The second heating device 22 is externally disposed at the rotary furnace 1 and fixed in the second heat preservation housing 52. That is, the first heat preservation housing 51 is externally disposed at the first furnace zone 11 of the rotary furnace 1. The first heating device 21 is located outside the first furnace zone 11 and within the first heat preservation housing 51. Moreover, the first heating device 21 is fixedly connected to the first heat preservation housing 51. The second heat preservation housing 52 is externally disposed at the second furnace zone 12 of the rotary furnace 1. The second heating device 22 is located outside the second furnace zone 12 and within the second heat preservation housing 52. Moreover, the second heating device 22 is fixedly connected to the second heat preservation housing 52.

In some embodiments, each of the heating device 2 and the heat preservation housing 5 may be fixed, and the rotary furnace 1 rotates with respect to the heat preservation housing 5 and the heating device 2. In this way, with the rotation of the rotary furnace 1, the heating device 2 can heat different positions of the rotary furnace 1 in a circumferential direction of the rotary furnace 1, to improve the temperature uniformity of the rotary furnace 1. Moreover, by fixing the heating device 2 in the heat preservation housing 5, an assembly process may be simplified, facilitating the mounting of the heating device 2.

Exemplarily, the rotary furnace 1 may be disposed horizontally, i.e., an axis of the rotary furnace 1 is horizontal. The heat preservation housing 5 may include an upper covering housing and a lower covering housing. The lower covering housing is internally provided with the heating device 2, and the upper covering housing is also internally provided with the heating device 2. The lower covering housing equipped with the heating device 2 is mounted in place, and then the rotary furnace 1 is hoisted above the lower covering housing. Then, the upper covering housing equipped with the heating device 2 is hoisted into place. Two side walls of the upper covering housing and two side walls of the lower covering housing are fastened by bolts, respectively. Such an arrangement can facilitate overall mounting of the equipment, as well as overhaul and maintenance, and replacement of the heating device 2 during use.

In some embodiments of the present disclosure, in combination with FIG. 3, each of the first heating device 21 and the second heating device 22 includes a heating unit 20. The heating unit 20 includes a plurality of electric heaters 201 arranged side by side in a length direction of the rotary furnace 1. Therefore, the first furnace zone 11 and the second furnace zone 12 can be heated throughout their entire length directions, which improves the heating effect. Moreover, in some examples, the plurality of electric heaters 201 in the heating unit 20 may be controlled separately, respectively. In this way, corresponding to the first furnace zone 11, stepwise heating can be achieved, which is beneficial to sintering. More specifically, a plurality of temperature zones, which are arranged at intervals in the length direction of the rotary furnace 1, may be divided by a heat preservation material in the first heat preservation housing 51. At least one electric heater 201 may be provided in each temperature zone, and each electric heater 201 may be independently controlled by a programmable logic controller (PLC). In this way, heating temperatures of the respective temperature zones can be different, to achieve gradient heating. For example, in a material feed direction, the temperature of the first furnace zone 11 rises in a stepwise manner, while the second furnace zone 12 may be sintered at a constant temperature.

In some embodiments of the present disclosure, in combination with FIG. 3, the rotary furnace 1 is provided with the heating unit 20 at each of a top and a bottom of the rotary furnace 1. Exemplarily, the first furnace zone 11 is provided with the heating unit 20 at each of a top and a bottom of the first furnace zone 11, and the second furnace zone 12 is provided with the heating unit 20 at each of a top and a bottom of the second furnace zone 12. Therefore, heating efficiency of the rotary furnace 1 can be improved by providing the heating unit 20 at each of a top and a bottom of the rotary furnace 1.

In some embodiments of the present disclosure, in combination with FIG. 3, the cooling device 3 includes a covering housing 31 and a spray device 32. The spray device 32 is externally disposed at the rotary furnace 1, and the covering housing 31 covers the spray device 32. Exemplarily, the covering housing 31 covers the third furnace zone 13, the spray device 32 is disposed inside the covering housing 31, and the rapping device 200 is disposed outside the covering housing 31. For example, the spray device 32 may spray the rotary furnace 1 to achieve cooling of the rotary furnace 1, and the covering housing 31 may recover the sprayed cooling liquid to achieve recycling and reusing purposes.

Therefore, by disposing the rapping device 200 outside the covering housing 31, the cooling liquid sprayed inside the covering housing 31 can be prevented from adversely affecting the operation of the rapping device 200, improving a striking effect. Moreover, the rapping device 200 is externally disposed at the covering housing 31 of the cooling device 3, facilitating the mounting and maintenance of the rapping device 200.

In some embodiments of the present disclosure, in combination with FIG. 2 and FIG. 4, the rapping device 200 further includes a third rapping device 63 disposed at a side of the heating zone 101 away from the heat preservation zone 102, i.e., the rapping device 200 further includes a third rapping device 63 disposed corresponding to a feed end of the first furnace zone 11. That is, the third rapping device 63 may strike corresponding to a feed position of the first furnace zone 11. In this way, for a reason that water vapor may occur in a feed material at a lower temperature and a problem of the material being bonded to the furnace wall caused by coal tar and other substances decomposed from raw materials during the initial sintering process of the material, improvement can be made through the striking of the third rapping device 63, further reducing the bonding problem and improving a material flow rate. It can be understood that when the rotary sintering furnace 1000 includes the first heat preservation housing 51, the third rapping device 63 may be disposed outside the first heat preservation housing 51, thereby facilitating the installation and maintenance of the third rapping device 63.

In some embodiments of the present disclosure, in combination with FIG. 2 and FIG. 9, the rapping device 200 further includes several fourth rapping devices 64 that are arranged at the heating zone 101 and/or the heat preservation zone 102, i.e., at least one of the heating zone 101 and the heat preservation zone 102 is provided with the fourth rapping device 64. Relative positional relationships between the fourth rapping device 64, the heat preservation housing 5, and the rotary furnace 1 are not limited. For example, the fourth rapping device 64 and the heat preservation housing 5 may be located outside the rotary furnace 1 or inside the rotary furnace 1. When the heating zone 101 is provided with the fourth rapping device 64, it is beneficial to striking on the over-sintered material bonded in the rotary furnace 1 at the heating zone 101, to be beneficial to reduce the adhesive skin materials and the contents of impurities in the discharging materials. When the fourth rapping device 64 is disposed at the heat preservation zone 102, it is beneficial to striking on the over-sintered material bonded in the rotary furnace 1 at the heat preservation zone 102, to be beneficial to reduce the adhesive skin materials and the contents of impurities in the discharging materials.

In some embodiments of the present disclosure, in combination with FIG. 1 and FIG. 3, the rotary sintering furnace 1000 further includes a support 300 and an air source device 400. The rapping device 200 includes a striking head 70 that is extendable. The support 300 is disposed outside the rotary furnace 1. The rotary furnace 1 is rotatable with respect to the support 300. The rapping device 200 is disposed at the support 300 and is configured to strike the rotary furnace 1. The air source device 400 is disposed at the support 300 and connected to the rapping device 200, to drive the striking head 70 to extend or retract to strike the rotary furnace 1. Exemplarily, any one of the first rapping device 61, the second rapping device 62, and the third rapping device 63 as described above may be constructed in the above-described form of being mounted in the support 300 and connected to the air source device 400.

Therefore, by mounting both the rapping device 200 and the air source device 400 on the support 300, neither the rapping device 200 nor the air source device 400 rotates together with the rotary furnace 1. When the rotary furnace 1 rotates with respect to the support 300, the rapping device 200 can strike the different positions of the rotary furnace 1 in the circumferential direction of the rotary furnace 1 with the rotation of the rotary furnace 1, thereby increasing the probability of the material being struck down. Moreover, both the rapping device 200 and the air source device 400 are mounted on the support 300 and do not rotate with the rotary furnace 1. In this way, air source pipelines 93 or electric wires can be prevented from being entangled, and operation reliability of the rapping device 200 can be thus improved. In addition, since the support 300 and the rotary furnace 1 are independent of each other, the rapping device 200 is easy to mount and can be removed or replaced at any time according to actual situations.

In some embodiments of the present disclosure, as shown in FIG. 1 and FIG. 3, an axis of the rotary furnace 1 is horizontally oriented. The rapping device 200 is disposed above a central horizontal plane S1 of the rotary furnace 1 (i.e., a horizontal plane passing through a central axis of the rotary furnace 1). Moreover, an angle a1 between a reciprocating direction of the striking head 70 of the rapping device 200 and the central horizontal plane S1 of the rotary furnace 1 ranges from 10° to 80°. For example, the angle a1 may be 10°, 20°, 30°, 40°, 50°, 60°, 70°, 80°, or the like. The rotary sintering furnace utilizes the rotation of its rotary furnace 1 around the axis of the rotary furnace 1 itself. Based on this, in combination with the spiral blade 1b inside the rotary sintering furnace, the material is pushed to move. When the rotary furnace 1 rotates, the material bonded to the furnace wall will move to the top along with the rotary furnace 1. Therefore, with the above arrangement, by striking diagonally above the rotary furnace 1 with the rapping device 200 and combining the striking with the gravity of the material itself, the material bonded to the furnace wall is more likely to fall off after the striking, which is thus beneficial to the improvement of the cleaning effect.

In some embodiments of the present disclosure, as shown in FIG. 1 and FIG. 3, the rotary furnace 1 is provided with one rapping device 200 at each of two sides of a central vertical plane S2 of the rotary furnace 1 (i.e. a vertical surface passing through the central axis of the rotary furnace 1). Moreover, the two rapping devices 200 are symmetrically arranged with respect to the central vertical plane S2. Moreover, an angle a2 between reciprocating directions of the two rapping devices 200 ranges from 30° to 120°. For example, the angle a2 may be 30°, 40°, 50°, 60°, 70°, 80°, 90°, 100°, 110°, 120°, or the like. Therefore, by striking symmetrically from the two sides, there are more striking points, which makes it easier for the bonded materials to fall off, further improving the cleaning effect. In addition, as actual needs, such as based on a discharge situation of the sintered material and a situation of a material retained on the sieve in a subsequent process, two rapping devices 200 may be selected to strike simultaneously or alternately, or only one of the two rapping devices 200 is used for striking, thus having good flexibility.

To realize the mounting of the two rapping devices 200, as shown in FIG. 1, the support 300 may be set as a door type, including two vertical frames 301 respectively located at two sides of the rotary furnace 1, and a horizontal frame 302 connected between upper ends of the two vertical frames 301, and inclined frames 303 connected between the two vertical frames 301 and the horizontal frame 302, with one rapping device 200 fixed to each of the inclined frames 303. The two vertical frames 301 are each provided with the air source device 400. Each rapping device 200 is connected to its adjacent air source device 400. Therefore, the support 300 has a good structural strength, which is beneficial to an improvement in operation stability and reliability of the rapping device 200 and satisfaction of mounting requirements for the two rapping devices 200 and the two air source devices 400.

In short, in order to ensure safe and stable operation, the rapping device 200 is fixed at a periphery of the rotary furnace 1 of the rotary sintering furnace 1000 using a door-shaped support 300. Meanwhile, the support 300 is fixed to the ground by bolts. The two rapping devices 200, which are arranged symmetrically with respect to each other, may be selected to operate simultaneously, alternately, or separately based on process requirements. The support 300 and the rotary furnace 1 are independent of each other, and are easy to mount. The rapping device 200 may be removed or replaced at any time based on situations.

It is worth noting that the number of rapping devices 200 is not limited to two. For example, only one rapping device 200 may be provided, such as directly above the rotary furnace 1. It is also beneficial to an arrangement of three or more rapping devices 200, as long as there is enough space, without limitation made herein.

In some embodiments of the present disclosure, the rotary furnace 1 is provided with a first cushion member 16 in a circumferential direction of the rotary furnace 1. One first cushion member 16 may be provided along the entire circumference of the rotary furnace 1, or a plurality of first cushion members 16 may be arranged at intervals along the entire circumference of the rotary furnace 1. The striking head 70 is configured to act on the first cushion member 16 to strike the rotary furnace 1 to prevent the striking head 70 from striking directly on the rotary furnace 1 for a long time and causing deformation or even damage. When the plurality of first cushion members 16 are arranged at intervals along the entire circumference of the rotary furnace 1, a predetermined spacing region is left between end portions of adjacent first cushion members 16 to serve as a space allowance for thermal expansion. The first cushion member 16 is made of the same material as the rotary furnace 1, to prevent the rotary furnace 1 from being heated during operation and thus reacting with the second cushion member 17 at the high temperature, resulting in corrosion of the rotary furnace 1.

In some embodiments of the present disclosure, as shown in FIG. 1 and FIG. 3, an air source pressure of the air source device 400 ranges from 0.35 MPa to 0.7 MPa. Therefore, the air source pressure may be adjusted within a wide range, to be flexibly adjusted specifically based on a specific material sintering process, an actual bonding situation, and a material of the furnace body 1a of the rotary furnace 1, which can avoid local deformation or even damage to the rotary furnace 1 caused by an excessive striking strength and balance the purpose of energy saving, while ensuring the striking strength for effective cleaning. For example, the air source pressure may be adjusted based on the discharge situation of the rotary furnace 1. For example, when the cladding material is determined to occur in the rotary furnace 1, in response to low pressure, little or no cladding material in the rotary furnace 1 is discharged from the rotary furnace 1. In this way, the air source pressure can be appropriately increased to strike down the cladding material, i.e., the air source pressure can be adaptively adjusted based on the actual situation, thereby improving the cleaning effect.

In some embodiments of the present disclosure, as shown in FIG. 1 and FIG. 3, a striking frequency of the rapping device 200 ranges from once per 5 seconds to once per 5 minutes. For example, the rapping device 200 may be struck once every 5 seconds, or once every 30 seconds, or once every 1 min, or once every 1.5 min, or once every 2 min, or once every 2.5 min, or once every 3 min, or once every 3.5 min, or once every 4 min, or once every 4.5 min, or once every 5 min, or the like. Thus, the striking frequency can be adjusted within a large range, and specific adjustments can be made flexibly based on the specific material sintering process, the actual bonding situation, the material of the furnace body 1a of the rotary furnace 1, and a rotational speed. While ensuring the striking frequency for effective cleaning, it is possible to avoid local deformation or even damage to the rotary furnace 1 caused by an excessively high striking frequency and a long-term fixed striking position, and balance the purpose of energy saving. For example, the striking frequency may be adjusted based on the discharge situation of the rotary furnace 1. For example, when the cladding material is determined to occur in the rotary furnace 1, in response to a long striking time interval, little or no cladding material in the rotary furnace 1 is discharged from the rotary furnace 1. In this way, an interval time can be appropriately shortened, i.e., the striking frequency can be increased to strike off the cladding material. That is, the striking frequency can be adaptively adjusted based on the actual situation, thereby improving the cleaning effect.

In the embodiments of the present disclosure, a striking opportunity may be set based on the specific situation. For example, striking can be performed during the sintering process or after the sintering is completed, or the striking can be performed during the sintering process and performed again after the sintering is completed. The striking can be performed by setting a striking time point. For example, the striking is performed once every few minutes or every few seconds.

When the rapping device 200 is connected to the air source device 400 to drive the rapping device 200 through the air source device 400 to strike, the rapping device 200 may be an air-hammer rapping device 7. The air-hammer rapping device 7 is pneumatically driven. The air-hammer rapping device 7 is driven by compressed air compressed by using an air compressor to strike the rotary furnace 1. A striking frequency, striking strength, and the like of the air-hammer rapping device 7 are controlled through the air source device 400. It is realized that a striking process is adjustable and controllable, and different actual requirements are matched. The air source device 400 may include an air source pressure control system 91, a solenoid valve 92, an air source pipe 93, and a time relay 94. The air source pressure control system 91 uses a filter pressure regulating valve to control the air source pressure, and freely selects to adjust the air source pressure to control the striking strength. The air-hammer rapping device 7 is controlled by the solenoid valve 92 through power on-off to operate. The time relay 94 may flexibly control the striking time and the striking interval time according to the process requirements, with a simple and convenient operation. An external switch freely controls the striking system to activate and deactivate.

Exemplarily, as shown in FIG. 1 and FIG. 5, a SK80 air-hammer rapping device 7 (with a use pressure ranging from 0.35 MPa to 0.7 MPa, an air consumption amount of 0.455 liters per stroke, an impact force ranging from 19.3 Ns to 29.5 Ns, a body weight of 7.9 kg, a total weight of 11.8 kg, and a body made of aluminum) is selected for use. In a state where no compressed air is supplied, a magnetic piston 73 (i.e., a piston internally provided with a permanent magnet 72) is fixed tightly on a metal substrate 71 by means of a strong magnetic force. When the solenoid valve 92 is energized, the compressed air flows into a body of the air-hammer rapping device 7, increasing pressure inside the body. When the pressure inside the body is greater than the magnetic force, the magnetic piston 73 is disengaged from the metal substrate 71 at a high speed, generating a strong counter-impact force due to a counter-acting force of the strong magnetic force. The magnetic piston 73 falling at the high speed transmits its impact force to the rotary furnace 1 through impact, and strikes down the bonded material in the rotary furnace 1 with the strong impact force. When the solenoid valve 92 stops being energized, the compressed air in the body of the air-hammer rapping device 7 is discharged through the solenoid valve 92, so that the magnetic piston 73 is slowly lifted by a return spring 832 to reapproach the metal substrate 71 and be bonded closely to the metal base plate 71 by the magnetic force, returning to an initial state of the magnetic piston 73. Through testing, after striking with the air-hammer rapping device 7, the proportion of the material retained on the sieve rises (ranging from 0.07% to 0.64%) after the material is sieved. The material retained on the sieve refers to the rest of parts of the produced material after being sieved, i.e., bonded caking or a cladding material with an oversize particle size. Therefore, it indicates that the striking can effectively strike down the bonded material or cladding material at the inner wall of the rotary furnace 1, which prevents caking bonded to the wall from being too large and over-sintered, and affecting material performance to some extent, or prevents the caking bonded to the wall from reacting with a wall surface of the rotary furnace 1 and producing impurities.

It can be understood that a type of the air-hammer rapping device 7 may be selected flexibly. For example, the type of the air-hammer rapping device 7 may be adjusted according to a wall thickness of the rotary furnace 1, a strength of the rotary furnace 1, and the like, to achieve different striking effects. More specifically, a suitable air-hammer rapping device 7 may be selected after the rotary furnace 1 is analyzed, so that the striking process will not cause deformation and other impacts on the structure of the rotary furnace 1. The magnetic piston 73 may serve as the striking head 70 or be connected to the striking head 70 to drive the striking head 70 to strike.

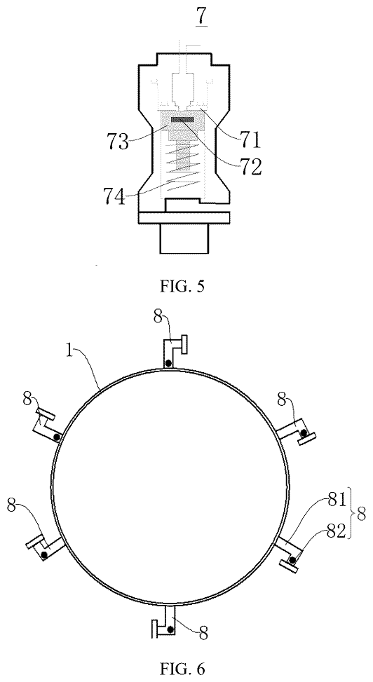

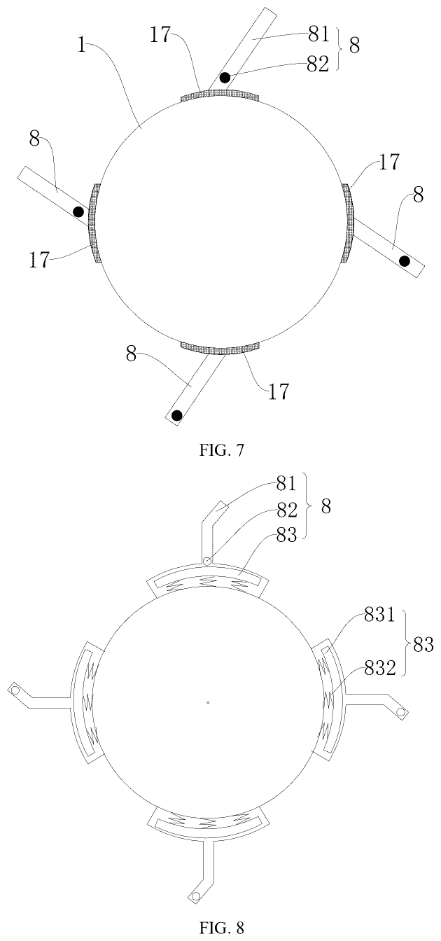

In some embodiments of the present disclosure, as shown in FIG. 6, the rapping device 200 includes a plurality of striking units 8 arranged at intervals in a circumferential direction of the rotary furnace 1. Exemplarily, any one of the first rapping device 61, the second rapping device 62, and the third rapping device 63 as described above may be constructed in the above-described form including the plurality of striking units 8 arranged at intervals in the circumferential direction of the rotary furnace 1. Each of the plurality of striking units 8 includes a pipe member 81 and a striking member 82. The pipe member 81 has an end fixed to the rotary furnace 1 and another end extending away from the central axis of the rotary furnace 1. For example, the pipe member 81 may be in an inclined form (for example, as shown in FIG. 7) or a bent form (for example, as shown in FIG. 6). The striking member 82 is disposed in the pipe member 81 and slidable with respect to the pipe member 81, and is configured to strike the rotary furnace 1.

Exemplarily, the rotational speed of the rotary furnace 1 ranges from 8 minutes per revolution to 15 minutes per revolution. Since the rotational speed of the rotary furnace 1 is slow, a centrifugal force of the striking member 82 approaches 0. During rotation of the pipe member 81 with the rotary furnace 1, when the pipe member 81 moves to a position directly above or diagonally above the rotary furnace 1, the striking member 82 slides downwards within the pipe member 81 under the action of gravity and directly or indirectly strikes on the rotary furnace 1. Since the pipe member 81 is in the inclined form (for example, as shown in FIG. 7), the bent form (for example, as shown in FIG. 6), or an arc form, the striking can be more efficiently performed.

For example, several hollow pipe members 81 are arranged at intervals at an outer wall of the rotary furnace 1 in the circumferential direction of the rotary furnace 1, and the pipe members 81 is internally provided with the striking member 82. When the rotary furnace 1 rotates, the striking member 82 moves inside the pipe members 81, falls off, and strikes against the outer wall of the rotary furnace 1. For example, the striking member 82 may be a ball, so that frictional resistance between the pipe member 81 and the striking member 82 can be reduced, lowering the loss.

In some embodiments of the present disclosure, in combination with FIG. 7, a second cushion member 17 is disposed in at least one of the pipe member 81 and the outer wall of the rotary furnace 1, and the striking member 82 acts on the second cushion member 17 to strike the rotary furnace 1 to provide a cushion effect, preventing the striking member from striking directly on the rotary furnace 1 for a long time and causing deformation or even damage. The second cushion member 17 may be made of a resilient material or preferably the same material as the rotary furnace 1 to prevent the rotary furnace 1 from being heated during operation and thus reacting with the second cushion member 17 at the high temperature, resulting in the corrosion of the rotary furnace 1.

In some embodiments of the present disclosure, as shown in FIG. 8, the pipe member 81 is internally provided with an elastic float 83 at an end of the pipe member 81 close to the rotary furnace 1. The elastic float 83 includes a float 831 and a spring 832. The spring 832 is configured to push the float 83 to move away from the rotary furnace 1. An area of the float 831 is greater than an area of the striking member 82. The striking member 82 is configured to strike the rotary furnace 1 by the float 831. It is worth noting that the elastic float 83 may include a floating member and the spring 832. The spring 832 pushes the floating member to move away from the rotary furnace 1. The striking member 82 strikes the floating member, and the floating member overcomes the force of the spring 832 and strikes on the rotary furnace 1. Since an area of the floating member is greater than the area of the striking member 82, a striking range can be improved, which is beneficial to the improvement of the cleaning effect. Meanwhile, a buffering effect can also be provided to prevent the striking member from directly striking on the rotary furnace 1 for a long time and causing damage.

In some embodiments of the present disclosure, as shown in FIG. 6, the rapping device 200 contains an unlimited number of striking units 8. For example, the number of striking units 8 is at least six, which is beneficial to striking at more positions and the improvement of the cleaning effect. Of course, the present disclosure is not limited thereto. The number of striking units 8 may be less than six, for example, may also be three, four (for example, as shown in FIG. 7 and FIG. 8), or five.

In some embodiments of the present disclosure, the striking units 8 in at least two rapping devices 200 arranged at intervals in an axial direction of the rotary furnace 1 may be arranged in alignment (such as with a cross-section of the rotary furnace 1 as a projection plane, projections of a plurality of striking units 8 in one of the rapping devices 200 on the projection plane coinciding with projections of a plurality of striking units 8 in another one of the rapping devices 200 on the projection plane in one-to-one correspondence), or arranged in a staggered manner (such as with the cross-section of the rotary furnace 1 as the projection plane, the projections of the plurality of striking units 8 in the one of the rapping devices 200 on the projection plane are staggered from the projections of the plurality of striking units 8 in the other one of the rapping devices 200 on that projection plane one-by-one). In this way, a flexible arrangement can be achieved. When the striking units 8 in the at least two rapping devices 200 arranged at intervals in the axial direction of the rotary furnace 1 are arranged in a staggered manner, overall striking points in the circumferential direction of the rotary furnace 1 are relatively numerous, which is beneficial to the improvement of the striking effect.

In some embodiments of the present disclosure, the driving device 4 is disposed between the heat preservation zone 102 and the cooling zone 103, i.e., the driving device 4 is disposed corresponding to the connection between the second furnace zone 12 and the third furnace zone 13, so that the driving device 4 is not close to an edge of the rotary furnace 1, and the influence of heat radiation can be reduced, enabling the driving device 4 to more reliably drive the whole rotary furnace 1 to rotate.

For example, in combination with FIG. 2 and FIG. 4, the driving device 4 may include a drive motor 41, a speed reducer 42, and a transmission gear 43. The rotary furnace 1 is provided with a gear ring 44 surrounding the rotary furnace 1. The transmission gear 43 is engaged with the gear ring 44. The drive motor 41 is configured to drive the transmission gear 43 through the speed reducer 42 to rotate. Therefore, the driving of the rotation of the rotary furnace 1 can be realized by the drive motor 41, the speed reducer 42, the transmission gear 43, and the gear ring 44. Moreover, it can be easy to make the rotational speed of the rotary furnace 1 low. For example, the rotational speed of the rotary furnace 1 may range from 8 minutes per revolution to 15 minutes per revolution.

In some embodiments of the present disclosure, the rotary sintering furnace 1000 is a lithium-iron-phosphate rotary sintering furnace. In combination with FIG. 9, the rotary furnace 1 includes the furnace body 1a and the spiral blade 1b. The spiral blade 1b is disposed at the inner wall of the furnace body 1a to synchronously rotate with the furnace body 1. Each of the furnace body 1a and the spiral blade 1b is made of stainless steel or an alloy material. Moreover, surfaces of the inner wall of the furnace body 1a and the spiral blade 1b are polished to make polishing degrees of the surfaces of the inner wall of the furnace body 1a and the spiral blade 1b smaller than 3 μm, and preferably smaller than 1.5 μm. Regarding the sintering of the lithium-iron-phosphate positive electrode material, a phenomenon where the material is bonded to the wall can be effectively reduced. In addition, by forming a coating of a specific material, such as a ceramic coating or an alloy coating on the inner wall of the furnace body 1a or the spiral blade 1b as described above, the inner wall of the furnace body 1a or the spiral blade 1b is imparted with surface smoothness, high-temperature resistance performance, and corrosion resistance performance, reducing the phenomenon of bonding to the wall or preventing the excessive sintering of the material after being bonded to the wall from causing the corrosion of the furnace body 1a, resulting in a magnetic substance content in the material exceeding the standard. Therefore, the rotary furnace 1 has relatively good high-temperature resistance performance. Moreover, since the surface of the rotary furnace 1 is smooth, it is beneficial to a reduction in a bonding rate of the material. For example, the rotary furnace 1 can be selected to be made of materials having resistance performance to a temperature ranging from 1,000° C. to 1,200° C. or resistance performance to higher temperatures, such as 304 stainless steel, 310S stainless steel, and Inconel 601/625 nickel-based high-temperature alloy, Inconel625 nickel-based high-temperature alloy, and materials having excellent stainless-steel corrosion resistance performance and good intergranular corrosion resistance performance, which can effectively improve introduction of magnetic substances to the lithium iron phosphate during high-temperature sintering.

It is worth noting that a length of the rotary furnace 1 is not limited. For example, the length of the rotary furnace 1 may range from 60 m to 70 m.

In summary, the rotary sintering furnace 1000 according to the embodiments of the present disclosure strikes on the rotary furnace 1 with the rapping device 200, making the material bonded to the wall fall off, which effectively solves a problem of the influence of the material bonded to the wall on the product quality and increases economic benefits.

In the description of the present disclosure, it needs to be understood that, orientation or position relationship indicated by terms such as “front”, “back”, “left”, “right”, “vertical”, “horizontal”, “top”, “bottom”, “in”, “out”, “axial”, “radial”, and “circumferential” is based on the orientation or position relationship shown in the accompanying drawings, and is merely for the convenience of describing the present disclosure and simplifying the description, rather than indicating or implying that the associated device or element must have a specific orientation, or be constructed and operated in a specific orientation, and therefore cannot be understood as a limitation on the present disclosure.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality of” means at least two unless otherwise specifically defined.

In the present disclosure, unless otherwise clearly specified and limited, terms such as “mount”, “connect”, “connect to”, “fix”, and the like should be understood in a broad sense. For example, it may be a fixed connection or a detachable connection or connection as one piece; mechanical connection or electrical connection; direct connection or indirect connection through an intermediate; internal communication of two components or the interaction relationship between two components. For those skilled in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

In the description of this specification, descriptions with reference to the terms “an embodiment”, “some embodiments”, “examples”, “specific examples”, or “some examples” etc., mean that specific features, structure, materials or characteristics described in combination with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, those skilled in the art can combine the different embodiments or examples and the features of the different embodiments or examples described in this specification without contradicting each other.

Although embodiments of the present disclosure have been illustrated and described, it is conceivable for those of ordinary skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A rotary sintering furnace, comprising:
a furnace body assembly comprising a heating zone, a heat preservation zone, and a cooling zone, wherein the furnace body assembly comprises a rotary furnace, a first heating device configured to heat the rotary furnace at the heating zone, a second heating device configured to heat the rotary furnace at the heat preservation zone, a cooling device configured to cool the rotary furnace at the cooling zone, and a driving device configured to drive the rotary furnace to rotate; and
a rapping device configured to strike the rotary furnace, wherein the rapping device comprises a first rapping device disposed between the heating zone and the heat preservation zone and/or a second rapping device disposed between the heat preservation zone and the cooling zone.

2. The rotary sintering furnace according to claim 1, wherein the furnace body assembly is provided with a first heat preservation housing at the heating zone and a second heat preservation housing at the heat preservation zone, the first heat preservation housing and the second heat preservation housing being spaced apart from each other, wherein:
the first rapping device is disposed at a spacing region between the first heat preservation housing and the second heat preservation housing; and/or
the second rapping device is disposed at a side of the second heat preservation housing away from the first heat preservation housing.

3. The rotary sintering furnace according to claim 2, wherein:
the first heating device is externally disposed at the rotary furnace and fixed in the first heat preservation housing;
the second heating device is externally disposed at the rotary furnace and fixed in the second heat preservation housing; and
each of the first heating device and the second heating device comprises a heating unit, wherein the heating unit comprises a plurality of electric heaters arranged side by side in a length direction of the rotary furnace.

4. The rotary sintering furnace according to claim 3, wherein the rotary furnace is provided with the heating unit at each of a top and a bottom of the rotary furnace.

5. The rotary sintering furnace according to claim 1, wherein the cooling device comprises a covering housing and a spray device, the spray device being externally disposed at the rotary furnace, and the covering housing covering the spray device.

6. The rotary sintering furnace according to claim 2, wherein the cooling device comprises a covering housing and a spray device, the spray device being externally disposed at the rotary furnace, and the covering housing covering the spray device.

7. The rotary sintering furnace according to claim 3, wherein the cooling device comprises a covering housing and a spray device, the spray device being externally disposed at the rotary furnace, and the covering housing covering the spray device.

8. The rotary sintering furnace according to claim 4, wherein the cooling device comprises a covering housing and a spray device, the spray device being externally disposed at the rotary furnace, and the covering housing covering the spray device.

9. The rotary sintering furnace according to claim 1, wherein:
the rapping device is externally disposed at the furnace body assembly; and/or
the rapping device further comprises a third rapping device disposed at a side of the heating zone away from the heat preservation zone; and/or
the rapping device further comprises several fourth rapping devices that are arranged at the heating zone and/or the heat preservation zone.

10. The rotary sintering furnace according to claim 2, wherein:
the rapping device is externally disposed at the furnace body assembly; and/or
the rapping device further comprises a third rapping device disposed at a side of the heating zone away from the heat preservation zone; and/or
the rapping device further comprises several fourth rapping devices that are arranged at the heating zone and/or the heat preservation zone.

11. The rotary sintering furnace according to claim 3, wherein:
the rapping device is externally disposed at the furnace body assembly; and/or
the rapping device further comprises a third rapping device disposed at a side of the heating zone away from the heat preservation zone; and/or
the rapping device further comprises several fourth rapping devices that are arranged at the heating zone and/or the heat preservation zone.

12. The rotary sintering furnace according to claim 1, further comprising a support and an air source device, wherein:
the rapping device comprises a rapping head that is extendable;
the support is disposed outside the rotary furnace, the rotary furnace being rotatable with respect to the support, and the rapping device being disposed at the support; and
the air source device is disposed at the support and connected to the rapping device to drive the rapping head to extend or retract to strike the rotary furnace.

13. The rotary sintering furnace according to claim 12, wherein:
an axis of the rotary furnace is horizontally oriented;
the rapping device is disposed above a central horizontal plane of the rotary furnace; and
an angle a1 between a reciprocating direction of the rapping head and the central horizontal plane of the rotary furnace ranges from 10° to 80°.

14. The rotary sintering furnace according to claim 13, wherein the rotary furnace is provided with one rapping device at each of two sides of a central vertical plane of the rotary furnace,
wherein the two rapping devices are symmetrically arranged with respect to the central vertical plane; and
wherein an angle a2 between reciprocating directions of the two rapping devices ranges from 30° to 120°.

15. The rotary sintering furnace according to claim 14, wherein the support comprises:
two vertical frames that are located at two sides of the rotary furnace, respectively;
a horizontal frame connected between the two vertical frames; and
inclined frames connected between the two vertical frames and the horizontal frame, the two vertical frames are each provided with the air source device, and the two rapping devices being mounted at the inclined frames.

16. The rotary sintering furnace according to claim 12, wherein:
the rotary furnace is provided with a first cushion member in a circumferential direction of the rotary furnace, and the rapping head is configured to act on the first cushion member to strike the rotary furnace; and/or
an air source pressure of the air source device ranges from 0.35 MPa to 0.7 MPa, and a striking frequency of the rapping device ranges from once per 5 seconds to once per 5 minutes.

17. The rotary sintering furnace according to claim 1, wherein the rapping device comprises a plurality of rapping units arranged at intervals in a circumferential direction of the rotary furnace, each of the plurality of rapping units comprising a pipe member and a rapping member, wherein:
the pipe member has an end fixed to the rotary furnace and another end extending away from a central axis of the rotary furnace; and
the rapping member is disposed in the pipe member and slidable with respect to the pipe member, the rapping member being configured to strike the rotary furnace.

18. The rotary sintering furnace according to claim 17, wherein:
a second cushion member is disposed in the pipe member and/or at an outer wall of the rotary furnace, the rapping member being configured to act on the second cushion member to strike the rotary furnace; and/or
the pipe member is internally provided with an elastic float at an end of the pipe member close to the rotary furnace, wherein the elastic float comprises a float and a spring, the spring being configured to push the float to move away from the rotary furnace, an area of the float being greater than an area of the rapping member, and the rapping member being configured to strike the rotary furnace by the float.

19. The rotary sintering furnace according to claim 1, wherein the driving device is disposed between the heat preservation zone and the cooling zone, wherein the driving device comprises a drive motor, a speed reducer, and a transmission gear, and wherein the rotary furnace is provided with a gear ring surrounding the rotary furnace, the transmission gear being engaged with the gear ring, wherein the drive motor is configured to drive the transmission gear through the speed reducer to rotate; and/or
a rotational speed of the rotary furnace ranges from 8 minutes per revolution to 15 minutes per revolution.

20. The rotary sintering furnace according to claim 1, wherein the rotary sintering furnace is a lithium-iron-phosphate rotary sintering furnace, and wherein the rotary furnace comprises a furnace body and a spiral blade, the spiral blade being disposed at an inner wall of the furnace body to synchronously rotate with the furnace body, and each of the furnace body and the spiral blade being made of stainless steel or alloy; and/or
a polishing degree of each of the inner wall of the furnace body and a surface of the spiral blade is smaller than 3 μm.
